(19) United States
(12) Patent Application Publication
(10) Pub. No.: US 2014/0004461 A1
(43) Pub. Date: Jan. 2, 2014

(54) TONER FOR ELECTROSTATIC LATENT IMAGE DEVELOPMENT AND METHOD FOR PRODUCING TONER FOR ELECTROSTATIC LATENT IMAGE DEVELOPMENT

(71) Applicant: KYOCERA Document Solutions Inc., Osaka-shi (JP)

(72) Inventor: Hidetoshi Miyamoto, Osaka-shi (JP)

(21) Appl. No.: 13/927,544

(22) Filed: Jun. 26, 2013

(30) Foreign Application Priority Data
Jun. 28, 2012 (JP) 2012-145844
Apr. 24, 2013 (JP) 2013-091637

(51) Int. Cl. G03G 9/087

(52) U.S. Cl. CPC G03G 9/08755
USPC 430/109.4; 430/137.14

(57) ABSTRACT

Toner particles in a toner for electrostatic latent image development are formed by aggregating fine particles containing a binder resin and fine particles containing a release agent, or fine particles containing a binder resin and a release agent in an aqueous medium to form aggregated particles, and heating the aggregated particles in an aqueous medium to coalesce components contained in the aggregated particles. The binder resin is a polyester resin, and has a content of oligomers having a molecular weight of 1000 or less in the toner, measured under pre-determined conditions, of 1000 mass ppm or less based on the mass of the toner.

### INCORPORATION BY REFERENCE

This application is based upon and claims the benefit of priority from the corresponding Japanese Patent Application Nos. 2012-145844 and 2013-091637, respectively filed in the Japan Patent Office on Jun. 28, 2012 and Apr. 24, 2013, the entire contents of which are incorporated herein by reference.

### FIELD

The present disclosure relates to a toner for electrostatic latent image development, and a method for producing a toner for electrostatic latent image development.

### BACKGROUND

In electrophotography, generally, a surface of a photosensitive drum is charged using corona discharge etc., followed by exposure using a laser etc. to form an electrostatic latent image. The formed electrostatic latent image is then developed with a toner to form a toner image. The formed toner image is further transferred onto a recording medium to obtain an image with high quality. For forming the toner image, typically, toner particles (toner base particles) with an average particle diameter of from 5 μm to 10 μm are used, which are obtained by mixing a binder resin, such as a thermoplastic resin, with toner components such as a colorant, a charge control agent, a release agent, a magnetic material, and then by subjecting the mixture to a kneading step, a pulverizing step, and a classifying step. In order to provide flowability and preferable electrostatic properties to the toner and/or to provide easy cleaning ability of the toner from the photosensitive drum surface, silica and/or inorganic fine particles such as those of titanium oxide are externally added to the toner base particles.

Such a toner is desired to have excellent fixability at low temperatures, which can be properly fixed without heating a fixing roller as much as possible, in terms of saving energy and the minimization of devices. In the production of a toner having excellent fixability at low temperatures, however, binder resins having a low melting point or a low glass transition point, or release agents having a low melting point are often used. For that reason, there are disadvantages in which such a toner is easily aggregated when it is stored at a high temperature, or filming easily occurs. The filming refers to a phenomenon in which a part of components contained in the toner are melted and they adhere to a surface of a latent image bearing member.

In order to obtain a toner capable of both suppressing filming and forming an image having a desired image density with good image quality, a method for producing a toner is proposed in which a binder resin including a polyester resin having units derived from a polyvalent carboxylic acid in a pre-determined amount, and having specific physical properties is neutralized and emulsified in an aqueous medium to thereby obtain a resin emulsion, and then resin fine particles in the resin emulsion are aggregated and coalesced to obtain a toner.

The method described above, however, has a problem that it is difficult to contain a sufficient amount of a release agent in toner particles. For this reason, according to the method described above, it is difficult to obtain a toner which can be properly fixed across a wide range of temperatures.

### SUMMARY

Toner particles in a toner for electrostatic latent image development according to a first aspect of the present disclosure are formed by aggregating fine particles containing a binder resin and fine particles containing a release agent in an aqueous medium to form aggregated particles, or by aggregating fine particles containing a binder resin and a release agent in an aqueous medium to form aggregated particles, and heating the resulting aggregated particles in an aqueous medium to coalesce components contained in the aggregated particles. The binder resin is a polyester resin.

The toner for electrostatic latent image development of the first aspect of the present disclosure has a component ratio Y (mass ppm) of oligomers having a molecular weight of 1000 or less in the toner, which is calculated in accordance with a method including the following steps (1) to (3). The component ratio Y is 1000 mass ppm or less. The step (1) is a step of obtaining an methanol extract, containing oligomer derived from the binder resin, by stirring 100 g of a sample of the toner for electrostatic latent image development in 500 g of methanol at 60° C. for 8 hours. The step (2) is a step of measuring a content of oligomers having a molecular weight of 1000 or less of oligomers contained in the methanol extract, and obtaining a mass X (g) of the oligomers having a molecular weight of 1000 or less contained in the whole amount of the methanol extract. The step (3) is a step of calculating the component ratio Y in accordance with the following formula:

Y=(X/100(the mass of the toner sample))×1000000.

A process for producing a toner for electrostatic latent image development according to another aspect of the present disclosure includes the following steps (I) to (III):

(I) a low oligomer resin production step in which at least a part of the oligomers having a molecular weight of 1000 or less contained in the polyester resin is removed from the polyester resin to produce a low oligomer resin which is a binder resin having a decreased oligomer content;

(II) an aggregated particles-forming step in which the fine particles of the low oligomer resin and fine particles of the release agent are aggregated in an aqueous medium to form aggregated particles, or fine particles containing the low oligomer resin and the release agent are aggregated in an aqueous medium to form aggregated particles; and

(III) a coalescing step in which the aggregated particles are heated in an aqueous medium to coalesce components contained in the aggregated particles.

### BRIEF DESCRIPTION OF DRAWINGS

FIG. 1 is a view that illustrates a method of measuring a softening point using a Koka-type flow tester.

### DETAILED DESCRIPTION

The present disclosure is explained in detail with respect to embodiments thereof below; however, the present disclosure is not limited at all to the embodiments and may be carried out with appropriately making a change within the purpose of the present disclosure. In addition, explanation may be occasionally omitted with respect to duplicated matters; this does not however limit the gist of the present disclosure.

### First Embodiment

A first embodiment of the present disclosure relates to a toner for electrostatic latent image development (hereinafter also referred to as a “toner”). The toner for electrostatic latent image development includes toner particles and the toner particles are formed by aggregating fine particles containing a binder resin and fine particles containing a release agent in an aqueous medium to form aggregated particles, or by aggregating fine particles containing a binder resin and a release agent in an aqueous medium to form aggregated particles, and heating the resulting aggregated particles in an aqueous medium to coalesce components contained in the aggregated particles. The toner particle contains a polyester resin as the binder resin. The component ratio of oligomers having a molecular weight of 1000 or less in the toner, measured in a pre-determined method, is 1000 mass ppm or less. In the present disclosure, the toner may consist of only toner particles or consist of toner particles and one or more components other than toner particles.

The toner particles in the toner of the first embodiment may contain optional components such as a colorant, a charge control agent and a magnetic powder, in addition to the binder resin and the release agent. The toner particles may have an external additive which is attached to the surface thereof, as required. The toner may be mixed with a desired carrier and used as a two-component developer. The binder resin, the release agent, the colorant, the charge control agent, the magnetic powder, and the external additive, which are essential or optional components of the toner particles in the toner of the first embodiment, and the carries, which are employed when the toner is used as the two-component developer, are explained below in order.

### [Binder Resin]

The toner particles in the toner of the present disclosure contain a polyester resin as the binder resin. The toner particles in the toner of the present disclosure has a component ratio of oligomers having a molecular weight of 1000 or less, which is measured in a pre-determined method, of 1000 mass ppm or less. Therefore, a polyester resin whose component ratio of oligomers having a molecular weight of 1000 or less is decreased is used as the binder resin contained in the toner particles in the toner according to the first embodiment.

When the toner particles are prepared using the polyester resin as the binder resin, a toner, which can be properly fixed at a wide temperature range and has excellent chromogenics, is easily produced. The polyester resin can be appropriately selected from polyester resins which have hitherto been used as a binder resin for toner. A polyester resin obtained by employing a method of condensation polymerization or co-condensation polymerization of an alcohol component and a carboxylic acid component can be used as the polyester resin. Components used in the synthesis of the polyester resin are exemplified by the following dihydric or tri- or more-hydric alcohol components and by bivalent or tri- or more-valent carboxylic acid components.

Specific examples of the divalent, trivalent or higher-valent alcohol components may be exemplified by diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, and polytetramethylene glycol; bisphenols such as bisphenol A, hydrogenated bisphenol A, polyoxyethylenated bisphenol A, and polyoxypropylenated bisphenol A; and trivalent or higher-valent alcohols such as sorbitol, 1,2,3,6-hexanetetrol, 1,4-sorbitane, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of the divalent, trivalent or higher-valent carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azealic acid, 1,10-decanedicarboxylic acid, malonic acid, or alkyl or alkenyl succinic acids including n-butyl succinic acid, n-butenyl succinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, isododecenylsuccinic acid; and trivalent or higher-valent carboxylic acids such as 1,2,4-benzene tricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, 1,2,4-cyclohexane tricarboxylic acid, tetra(methylenecarboxyl)methane, 1,2,7,8-octanetetracarboxylic acid, pyromellitic acid, and Enpol trimer. These divalent, trivalent or higher-valent carboxylic acids may be used as ester-forming derivatives such as an acid halide, an acid anhydride, and a lower alkyl ester. Here, the term “lower alkyl” means an alkyl group of from 1 to 6 carbon atoms.

The polyester resin has preferably an acid value of 10 mg KOH/g or more and 40 mg KOH/g or less. When toner particles are produced using a polyester resin whose acid value is too low, the aggregation of fine particles may be improperly advanced depending on the formulation in a step (II) described below. A toner, which includes toner particles containing a polyester resin whose acid value is too high as the binder resin, may possibly have impaired toner properties under high humidity conditions due to the moisture. The acid value of the polyester resin can be controlled by controlling a balance of hydroxyl groups in the alcohol component, and carboxyl groups in the carboxylic acid component, used in the synthesis of the polyester resin.

The polyester resin has preferably a softening point of 70° C. or higher and 140° C. or lower. In cases of using a toner, which includes toner particles containing a polyester resin with an excessively high softening point as the binder resin, it may be difficult to properly fix the toner at lower temperatures. In cases of using a toner, which includes toner particles containing a polyester resin with an excessively low softening point as the binder resin, heat-resistant storage stability may degrade such that the toner agglomerates during storage at higher temperatures. The softening point of the polyester resin can be measured in accordance with the method below.

### Method of Measuring Softening Point

The softening point of the polyester resin (toner) is measured using an elevated flow tester (CFT-500D, manufactured by Shimadzu Corporation). A polyester resin of 1.5 g is used as a sample, and a die of 1.00 mm height and 1.00 mm diameter is used. Measurement is performed under conditions of a temperature-increase rate 4° C./min, pre-heat time 300 seconds, load 5 kg, and measuring temperature range from 60° C. to 200° C. The softening point of the polyester resin can be read from an S-shaped curve that is obtained from the measurement using the flow tester and that shows a relationship between temperature (° C.) and stroke (mm).

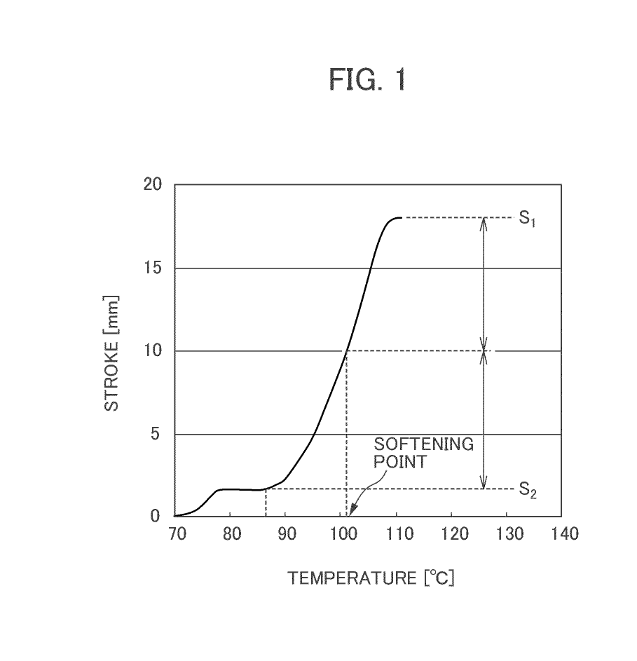

The way to read the softening point is explained with reference to FIG. 1. A maximum stroke value is defined as S₁, and a base line stroke value on the lower temperature side is defined as S₂. The temperature at which the stroke value is (S₁+S₂)/2 on the S-shaped curve is defined as the softening point of the polyester resin.

Preferably, the glass transition point (Tg) of the polyester resin is from 50° C. or higher and 70° C. or lower. In cases of using a toner, which includes toner particles containing a polyester resin with an excessively low glass transition temperature as the binder resin, toner particles may be fusion-bonded to each other in a development unit of an image-forming apparatus, or a part of the toner particles may be fusion-bonded to each other during transport of a toner container or storage in a warehouse, due to deteriorated storage stability of the toner. In cases of using a toner, which includes toner particles containing a polyester resin with an excessively low glass transition temperature as the binder resin, the toner easily adheres to image bearing members, due to the low strength of the polyester resin. In cases of using a toner, which includes toner particles containing a polyester resin with an excessively high glass transition temperature as the binder resin, the toner tends to be less properly fixed at lower temperatures.

The glass transition point of the polyester resin can be determined from a point of variation of the specific heat of the polyester resin using a differential scanning calorimeter (DSC) in accordance with JIS K 7121. More specifically, the measurement method is as follows:

It can be determined by measuring an endothermic curve of the polyester resin using a differential scanning calorimeter DSC-6200, manufactured by Seiko Instruments Inc., as a measuring device. Ten mg of a sample to be measured is loaded into an aluminum pan and an empty aluminum pan is used as a reference. An endothermic curve of a polyester resin is obtained under a condition of measuring of the temperature range from 25° C. to 200° C., a temperature-increase rate 10° C./min, with normal temperature and normal humidity, and then the glass transition point of the polyester resin can be determined from the obtained endothermic curve.

The polyester resin has preferably a number average molecular weight (Mn) of 1,000 or more and 10,000 or less. When toner particles in the toner is produced using the polyester resin with the number average molecular weight (Mn) within the range described above, a toner which can be properly fixed at wide temperature ranges can be obtained. A molecular weight distribution (Mw/Mn), expressed by a ratio of a mass average molecular weight (Mw) to a number average molecular weight (Mn), of the polyester resin is preferably 2 or more and 10 or less. When toner particles in a toner are produced using the polyester resin with the molecular weight distribution within such a range, a toner having excellent fixability at low temperatures can be easily obtained. The number average molecular weight (Mn) and the mass average molecular weight (Mw) of the polyester resin can be measured using gel permeation chromatography.

The kind of the polyester, which is used as the binder resin, is not particularly limited, so long as it can provide a toner having a component ratio of oligomers having a molecular weight of 1000 or less in the toner, measured in a pre-determined method, of 1000 mass ppm or less. Usually, the polyester resin is preferably a polyester resin which has been subjected to some treatment of reducing the component ratio of the oligomer.

In the claims and the specification of the present application, a polyester resin, which has been subjected to a treatment of removing at least a part of oligomers contained in the resin, or to a treatment of reducing a production amount of oligomers in a synthetic stage, is referred to as a “low oligomer resin.”

The component ratio of the oligomers having a molecular weight of 1000 or less in the polyester resin, measured in a pre-determined method, in the binder resin (polyester resin) is controlled to a pre-determined range, so that the component ratio of oligomers having a molecular weight of 1000 or less in the toner, measured in a pre-determined method, is 1000 mass ppm or less.

Due to the increased recent requirement for improved image qualities, the minimization of a toner diameter has been advanced. The minimization of the toner diameter results in improvement in fine-line reproducibility and in improvement of image quality of formed images. An emulsion aggregation method is known as a preferable method for obtaining such a toner with a small particle diameter in which fine particles of the components contained in the toner such as the binder resin, the release agent, and the colorant are aggregated in an aqueous medium to form aggregated particles, and the resulting aggregated particles are heated in an aqueous medium to coalesce components contained in the aggregated particles, thereby obtaining toner particles.

In order to obtain a toner having excellent fixability at low temperatures, in general, a binder resin of which average molecular weight is controlled to be low is often used as a binder resin having a low melting point and/or glass transition point. Further, a polyester resin is often used as a binder resin of which average molecular weight is controlled to be low, because the average molecular weight thereof can be easily controlled. When the average molecular weight of the binder resin is controlled to be low, then the amount of low molecular weight components is increased in the binder resin. The low molecular weight components contained in the binder resin contribute to fixability improvement of a toner at low temperatures.

According to the present inventors' studies, however, it has been proved that if a toner is produced in the emulsion aggregation method described above using a polyester resin of which molecular weight is controlled to be low, i.e., a polyester resin having a large amount of an oligomer component with a low molecular weight as the binder resin, it is difficult to incorporate a release agent in aggregated particles when the fine particles are aggregated.

In such a case, even if the polyester resin having a low molecular weight is used for improving the fixability at low temperatures, it is difficult to obtain a toner having excellent fixability at low temperatures, because the release agent also contributes to fixability improvement at low temperatures.

According to the present disclosure, the amount of the oligomers contained in the polyester resin as the binder resin is decreased so that the component ratio of oligomers having a molecular weight of 1000 or less in the toner is 1000 mass ppm or less. A large amount of the release agent can be contained in the toner particles obtained in the emulsion aggregation method described above by decreasing the amount of the oligomers in the polyester resin,

whereby the toner having excellent fixability at low temperatures can be obtained.

### Calculation Method of Component Ratio of Oligomers in Toner

The component ratio Y (mass ppm) of oligomers having a molecular weight of 1000 or less in the toner can be calculated by a method including

the steps (1) to (3) described below.

(1) a step of obtaining a methanol extract, containing oligomer derived from the binder resin, by stirring 100 g of a sample of the toner for electrostatic latent image development in 500 g of methanol at 60° C. for 8 hours,

(2) a step of measuring the content of oligomers having a molecular weight of 1000 or less of oligomers contained in the methanol extract, and obtaining a mass X (g) of the oligomers having a molecular weight of 1000 or less contained in the whole amount of the methanol extract, and

(3) a step of calculating the component ratio in accordance with the following formula:

Y=(X/100)×1000000.

The method for measuring the amount of oligomers having a molecular weight of 1000 or less in the oligomers contained in the methanol extract is not particularly limited. The amount of the oligomers having a molecular weight of 1000 or less contained in the methanol extract can be measured by using a known analysis method such as infrared spectroscopy (IR), ultraviolet spectroscopy, nuclear magnetic resonance spectroscopy (NMR), high performance liquid chromatography (HPLC), gel permeation chromatography (GPC) or mass spectrometry. It is preferable to measure the amount of the oligomers having a molecular weight of 1000 or less using GPC among the methods described above. The method for measuring the amount of the oligomers having a molecular weight of 1000 or less using GPC is explained below.

### (Method for Measuring Amount of Oligomers Having Molecular Weight of 1000 or Less Using GPC)

Tetrahydrofuran (THF) was used as a medium. A sample to be measured is dissolved in THF in a concentration preferably of 0.1 mg/mL or more and 5 mg/mL or less, more preferably 0.5 mg/mL or more and 2 mg/mL or less. The sample is dissolved in THF by stirring as usual, or a method such as ultrasonic irradiation in an ultrasonic wave bath. The obtained THF solution is passed through a filter to obtain a sample solution for measurement. The GPC measurement is performed by using an apparatus described below under conditions described below. Specifically, after a column is stabilized at a temperature of 40° C., the THF solution was flowed through the column at the same temperature at a flow rate of 0.35 ml/min, whereby the measurement using GPC is performed. Using a calibration curve, produced using several kinds of monodispersed polystyrenes, a molecular weight distribution of a sample is measured as a molecular weight in terms of polystyrene. It is preferable to make the calibration curve based on measurements using at least 10 points, from the viewpoint of the accuracy. An RI (index of refraction) detector or a UV (ultraviolet light) detector can be used as the detector. The RI detector is preferable because it allows the detection regardless of the composition of the sample. Combination of standard polystyrene gel columns can be used as the column.

A GPC of a monodispersed standard polystyrene having a number average molecular weight of 1000 is measured, a retention volume (mL) is obtained at a peak position, and it is defined as RVS. A GPC of a residue, which is obtained by distilling methanol away from the methanol extract, is measured. The ratio of an area of a part of RVS or less on the low molecule side to the whole area of the peak of the GPC chromatogram is calculated. In this step, a differential refractometer is usually used as the detector, but only an oligomer part is separately fractionated by a preparative liquid chromatography, and the monomer composition of the oligomer part is detected by using an apparatus including thermal cracking gas chromatography, an infrared spectrophotometer, or a proton nuclear magnetic resonance measuring apparatus. At this time, when the composition of the oligomer part is the same as the composition of the whole copolymer, it can be assumed that there is no difference in the index of refraction between the oligomer part and the whole copolymer, and a peak area ratio of the oligomer part to the whole copolymer can be expressed as a mass ratio of the oligomer part to the whole copolymer. The amount of the oligomer having a molecular weight of 1000 or less, accordingly, can be obtained by calculating an area ratio of the oligomer part to the whole copolymer in the peak area of the chromatogram.

GPC Measurement Condition

Apparatus: HLC-8320 (manufactured by Tosoh Corporation)

Eluent: THF (tetrahydrofuran)

Column: TSK gel SuperMultipore HZ-M (manufactured by Tosoh Corporation)

The number of columns: Three

Detector: RI

Eluent Flow Rate: 0.35 mL/min

Concentration of Sample Solution: 2.0 g/L

Column Temperature: 40° C.

Amount of Sample Solution: 10 μL

Preparation of Sample Solution: After the eluent and the sample are shaken for one hour using a shaker, the sample is dissolved in the eluent, and the solution is passed through a filter (pore size 5 μm).

Calibration Curve: Produced using standard polystyrene

When the polyester resin is a resin synthesized using monomers containing aromatic rings such as polyoxyethylenated bisphenol A or polyoxypropylenated bisphenol A, it is preferable to use high performance liquid chromatography provided with an UV detector for measuring the content of the oligomers having the specified molecular weight or less in methanol.

### [Release Agent]

The toner particles in the toner includes the release agent for the purpose of improving fixability and offset resistance. The type of the release agent may be those of conventional release agents used for toners heretofore without particularly limitation.

Preferable release agents may include aliphatic hydrocarbon waxes such as low molecular mass polyethylene, low molecular mass polypropylene, polyolefin copolymer, polyolefin wax, microcrystalline wax, paraffin wax, and Fischer-Tropsch wax; oxides of aliphatic hydrocarbon wax such as oxidized polyethylene wax and block copolymer of oxidized polyethylene wax; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; waxes containing a fatty acid ester as a main component such as montanate ester wax and castor wax; and waxes obtained by deoxidization of a part or whole of fatty acid ester such as deoxidized carnauba wax.

The release agent, which can be preferably used, may further include saturated straight-chain fatty acids such as palmitic acid, stearic acid, montanic acid, and long-chain alkyl carboxylic acids having a long-chain alkyl group; unsaturated fatty acids such as brassidic acid, eleostearic acid, and valinaphosphoric acid; saturated alcohols such as stearyl alcohol, eicosyl alcohol, behenyl alcohol, Cal Now building alcohol, ceryl alcohol, mericyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, N,N′-dioleylsebacic acid amide, and aromatic bisamides such as m-xylenebisstearic acid amide, and N,N′-distearyl isophthalic acid amide; fatty acid metal salts such as calcium stearate, calcium laurate, zinc stearate, and magnesium stearate; waxes in which a vinyl monomer such as styrene or acrylic acid is grafted onto an aliphatic hydrocarbon wax; partial esterized compound of a fatty acid and a polyhydric alcohol such as monoglyceride of behenic acid; and methyl ester compounds having a hydroxyl group obtained by hydrogenation of a vegetable fat and oil.

The amount of the release agent used is preferably 8% by mass or more and 20% by mass or less, more preferably, 10% by mass or more and 15% by mass or less, based on the mass of the toner particles. In case of using a toner, which includes toner particles containing an excessively small amount of the release agent, a desired effect of suppressing occurrence of offsets or image-smearing, in the formed image, may not be sometimes obtained. Particles of a toner having an excessively large amount of the release agent used may be easily fusion-bonded to each toner particle, and thus the storage stability may be sometimes degraded. According to a method for producing a toner for electrostatic latent image development of the present disclosure, described below, even if a large amount of the release agent is contained in the toner particles of the toner, a toner having a good balance between the fixability at low temperatures and the heat-resistant storage stability can be easily obtained, because dropping of the release agent from the surface of the toner particles and bleeding out of the release agent from the inside of the toner particles are suppressed.

### [Colorant]

The colorant contained in the toner particles of the toner for electrostatic latent image development of the present disclosure may be selected from conventional pigments and dyes depending on the color of toner particles. Specific examples of a preferable colorant added to the toner particles may include following colorants.

Black colorants may include carbon black. Specific examples thereof may include Raven 1060, 1080, 1170, 1200, 1250, 1255, 1500, 2000, 3500, 5250, 5750, 7000, or 5000, ULTRAII and 1190 ULTRAII manufactured by Columbian Carbon Company; Black Pearl sL, Mogul-L, Rega 1400R, 660R or 330R, and Monarch 800, 880, 900, 1000, 1300 or 1400 manufactured by Cabot Corporation; Color Black FW 1, FW 2, FW 200, 18, S 160, S170, Special Black 4, 4A, 6, Printex 35, U, 140U, V, and 140V manufactured by Degussa Corporation; and No. 25, 33, 40, 47, 52, 900, 2300, MCF-88, MA 600, 7, 8, and 100 manufactured by Mitsubishi Chemical Corporation. As the black colorant, a colorant obtained by color-mixing of a yellow colorant, a magenta colorant and a cyan colorant described below, may be utilized. A colorant for color toner may include a yellow colorant, a magenta colorant, a cyan colorant, and the like.

Yellow colorants may be exemplified by those of condensed azo compounds, isoindolinone compounds, anthraquinone compounds, azo metal complexes, methine compounds, and allylamide compounds. Specifically, C.I. pigment yellows 3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, and 194; Naphthol Yellow S, Hansa Yellow G, and C.I. Vat Yellow may be exemplified.

Magenta colorants may be exemplified by those of condensed azo compounds, diketo-pyrrolo-pyrrole compounds, anthraquinone compounds, quinacridone compounds, basic dye lake compounds, naphthol compounds, benzimidazolone compounds, thioindigo compounds, and perylene compounds. Specifically, C.I. pigment reds 2, 3, 5, 6, 7, 19, 23, 48:2, 48:3, 48:4, 57:1, 81:1, 122, 144, 146, 150, 166, 169, 177, 184, 185, 202, 206, 220, 221, and 254 may be exemplified.

Cyan colorants may be exemplified by those of copper phthalocyanine compounds, copper phthalocyanine derivatives, anthraquinone compounds, and basic dye lake compounds. Specifically, C.I. pigment blues 1, 7, 15, 15:1, 15:2, 15:3, 15:4, 60, 62, and 66, Phthalocyanine Blue, C.I. Vat Blue, and C.I. Acid Blue may be exemplified.

In each color, the colorants may be used alone or as a mixture thereof. The amount of the colorant used is preferably 3% by mass or more and 15% by mass or less based on the mass of the toner.

### [Charge Control Agent]

The toner may contain a charge control agent as required. The charge control agent is used for the purpose of improving a charge level stability of the toner or a charge-increasing property, which gives an indication of chargeability to a predetermined charge level within a short time, to thereby obtain a toner with excellent durability and stability. When developing by positively charging the toner, a positively chargeable charge control agent is used; and when developing by negatively charging the toner, a negatively chargeable charge control agent is used.

The charge control agent may be appropriately selected from those used for toners heretofore. Specific examples of the positively chargeable charge control agent may be exemplified by azine compounds such as pyridazine, pyrimidine, pyrazine, ortho-oxazine, meta-oxazine, para-oxazine, ortho-thazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes consisting of azine compounds such as azine Fastred FC, azine Fastred 12BK, azine Violet BO, azine Brown 3G, azine Light Brown GR, azine Dark Green BH/C, azine Deep Black EW, and azine Deep Black 3RL; nigrosine compounds such as nigrosine, nigrosine salts, and nigrosine derivatives; acid dyes consisting of nigrosine compounds such as nigrosine BK, nigrosine NB, and nigrosine Z; metal salts of naphthenic acid or higher fatty acid; alkoxylated amines; alkylamides; quaternary ammonium salts such as benzylmethylhexyldecyl ammonium and decyltrimethylammonium chloride. Among these positively chargeable charge control agents, nigrosine compounds are particularly preferable since more rapid charge-increasing property may be obtained. These positively chargeable charge control agents may be used in a combination of two or more.

In addition, resins having a quaternary ammonium salt, a carboxylic acid salt, or a carboxyl group as a functional group may be used as the positively chargeable charge control agent. More specifically, styrene resins having a quaternary ammonium salt, acrylic resins having a quaternary ammonium salt, styrene-acrylic resins having a quaternary ammonium salt, polyester resins having a quaternary ammonium salt, styrene resins having a carboxylic acid salt, acrylic resins having a carboxylic acid salt, styrene-acrylic resins having a carboxylic acid salt, polyester resins having a carboxylic acid salt, styrene resins having a carboxylic group, acrylic resins having a carboxylic group, styrene-acrylic resins having a carboxylic group, and polyester resins having a carboxylic group, may be exemplified. The molecular mass of these resins is not particularly limited within a range not inhibiting the purpose of the present disclosure; and oligomers or polymers may also be allowable.

Styrene-acrylic resins having a quaternary ammonium salt as a functional group among the resins can be used as the positively chargeable charge control agent, because it can easily control the charge amount to a value within a desired range. Specific examples of the preferable acrylic comonomer, which is copolymerized with styrene units when the styrene-acrylic resin having the quaternary ammonium salt as the functional group is synthesized, may include alkyl esters of (meth)acrylic acid such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

As the quaternary ammonium salt, a unit derived from a dialkyl aminoalkyl(meth)acrylate, a dialkyl amino(meth)acrylamide, or a dialkyl aminoalkyl(meth)acrylamide via quaternization step is used. Specific examples of the dialkyl aminoalkyl(meth)acrylate may include dimethyl aminoethyl(meth)acrylate, diethyl aminoethyl(meth)acrylate, dipropyl aminoethyl(meth)acrylate, and dibutyl aminoethyl(meth)acrylate. Specific examples of the dialkyl(meth)acrylamide may include dimethyl methacrylamide. Specific examples of the dialkyl aminoalkyl(meth)acrylamide may include dimethyl aminopropyl methacrylamide. A hydroxyl group-containing polymerizable monomer such as hydroxyethyl(meth)acrylate, hydroxypropyl(meth)acrylate, 2-hydroxybutyl(meth)acrylate or N-methylol(meth)acrylamide may be used together during the polymerization.

Specific examples of the negatively chargeable charge control agent may be exemplified by organic metal complexes and chelate compounds. The organic metal complex and the chelate compound are preferably acetylacetone metal complexes such as aluminum acetylacetonate and iron (II) acetylacetonate and salicylic acid metal complexes or salicylic acid metal salts such as 3,5-di-tert-butylsalicylic acid chromium and more preferably salicylic acid metal complexes or salicylic acid metal salts. These negatively chargeable charge control agents may be used in a combination of two or more.

Typically, the amount of the positively chargeable or negatively chargeable charge control agent used is preferably 1.5 parts by mass or more and 15 parts by mass or less, more preferably 2.0 parts by mass or more and 8.0 parts by mass or less, and particularly preferably 3.0 parts by mass or more and 7.0 parts by mass or less, based on 100 parts by mass of the total amount of the toner particles. In cases of using a toner, which includes toner particles where the amount of the charge control agent used is excessively small, image density of formed images may be less than an intended value or image density is unlikely to be maintained for a long period since the toner particles are resistant to stable charging to a predetermined polarity. In this case also, fogging tends to appear in formed images, or smear caused by the toner components, tends to occur at latent image bearing members since the charge control agent is resistant to uniform dispersal into the binder resin. In cases of using a toner, which includes toner particles where the amount of the charge control agent used is excessively large, problems such as smear at latent image bearing members, caused by the toner components, and image defects in formed images due to inferior charge under a high temperature and high humidity are likely to occur, with degradation of environment resistance of the toner.

### [Magnetic Powder]

The toner particles of the toner for electrostatic latent image development may be compounded with a magnetic powder, as required. Preferable examples of the magnetic powder may be exemplified by iron oxides such as ferrite and magnetite, ferromagnetic metals such as those of cobalt and nickel, alloys of iron and/or ferromagnetic metals, compounds of iron and/or ferromagnetic metals, ferromagnetic alloys via ferromagnetizing treatment like heat-treatment, and chromium dioxide.

Particle diameter of the magnetic powder is preferably 0.1 μm or more and 1.0 μm or less, and more preferably 0.1 μm or more and 0.5 μm or less. A magnetic powder within this range of particle diameter may be easily dispersed into the binder resin.

In order to improve dispersibility of the magnetic powder into the binder resin, magnetic powder whose surface is surface-treated by using a surface treatment agent such as a titanium coupling agent and a silane coupling agent may also be used.

In cases of using the toner as a one-component developer, the amount of the magnetic powder used is preferably 35 parts by mass or more and 60 parts by mass or less, and more preferably 40 parts by mass or more and 60 parts by mass or less, based on 100 parts by mass of the total amount of the toner particles. In cases of using a toner, which includes toner particles where the amount of the magnetic powder used is excessively large, image density of formed images is unlikely to be maintained at a desired value for a long period or it may be remarkably difficult to fix toner images. In cases of using a toner, which includes toner particles where the amount of the magnetic powder used is excessively small, fogging tends to appear in formed images or image density of formed images is unlikely to be maintained at a desired value for a long period. In cases of using the toner as a two-component developer, the amount of the magnetic powder used is preferably 20% by mass or less, more preferably 15% by mass or less based on 100 parts by mass of the total amount of the toner partilces.

### [External Additive]

The toner particles of the toner may be surface-treated with the external additive as desired. The external additive can be appropriately selected from conventional external additives used for toners heretofore. Specific examples of the preferable external additive may include silica and metal oxides such as alumina, titanium oxide, magnesium oxide, zinc oxide, strontium titanate, and barium titanate. These external additives may be used in a combination of two or more. The external additive may be used in a hydrophobized state which is obtained by using a hydrophobing agent such as an aminosilane coupling agent or silicone oil. When the hydrophobized external additive is used, the decrease in the charge amount of the toner particles can be easily suppressed at a high temperature and high humidity, and thus a toner having excellent flowability can be easily obtained.

Particle diameter of the external additive is preferably 0.01 μm or more and 1.0 μm or less.

The amount of the external additive used is preferably 0.1 parts by mass or more and 10 parts by mass or less, based on 100 parts by mass of the toner particles before the external addition treatment (toner base particles), more preferably 0.2 parts by mass or more and 5 parts by mass or less.

### [Carrier]

The toner may be mixed with a desired carrier and used as a two-component developer. In cases of preparing the two-component developer, a magnetic carrier is preferably used.

A carrier, whose carrier core material is coated with a resin, may be exemplified as a preferable carrier in cases of using the toner for electrostatic latent image development as the two-component developer. Specific examples of the carrier core material may be exemplified by metal particles of iron, oxidized iron, reduced iron, magnetite, copper, silicon steel, ferrite, nickel, or cobalt; alloy particles of these materials and metals such as manganese, zinc, and aluminum; alloy particles such as iron-nickel alloy or iron-cobalt alloy; ceramic particles of titanium oxide, aluminum oxide, copper oxide, magnesium oxide, lead oxide, zirconium oxide, silicon carbide, magnesium titanate, barium titanate, lithium titanate, lead titanate, lead zirconate, or lithium niobate; particles of higher permittivity materials such as ammonium dihydrogen phosphate, potassium dihydrogen phosphate, and Rochelle salts; resin carriers containing these magnetic particles dispersed in resins; and the like.

Specific examples of the resin, which coats the carrier core material, may be exemplified by (meth)acrylic polymers, styrene polymers, styrene-(meth)acrylic copolymers, olefin polymers (polyethylene, chlorinated polyethylene, and polypropylene), polyvinyl chloride, polyvinyl acetate, polycarbonate, cellulose resins, polyester resins, unsaturated polyester resins, polyamide resins, polyurethane resins, epoxy resins, silicone resins, fluorine resins (polytetrafluoroethylene, polychlorotrifluoroethylene, and polyvinylidene fluoride), phenol resins, xylene resins, diallyl phthalate resins, polyacetal resins, and amino resins. These resins may be used in a combination of two or more.

Particle diameter of the carrier is preferably 20 μm or more and 120 μm or less, and more preferably 25 μm or more 80 μm or less as a particle diameter measured by an electron microscope.

When the toner is used as a two-component developer, the content of the toner in the two-component developer is preferably 3% by mass or more and 20% by mass or less, based on the mass of the two-component developer, more preferably 5% by mass or more and 15% by mass or less. By adjusting the content of the toner in the two-component developer within this range, images with an appropriate image density may be continuously formed, and pollution inside image forming apparatuses due to the toner or adhesion of the toner to recorded media such as transfer paper may be suppressed because of inhibited scattering of the toner from development units.

The toner for electrostatic latent image development of the first embodiment as explained above contains a large amount of the release agent in the binder resin, and can be properly fixed at a wide temperature range including a lower temperature range. The toner for electrostatic latent image development of the first embodiment, accordingly, can be preferably used in various image-forming apparatuses.

Although the method for producing the toner particles of the toner of the first embodiment is not suitable limited, and preferable production methods may be exemplified by a method for producing toner particles of a toner for electrostatic latent image development of a second embodiment described below. The method for producing the toner particles of the toner for electrostatic latent image development of the second embodiment is explained below in detail.

### Second Embodiment

The second embodiment of the present disclosure relates to a method for producing the toner particles of the toner for electrostatic latent image development of the first embodiment.

The method for producing the toner particles of the toner for electrostatic latent image development of the second embodiment of the present disclosure

includes the following steps (I) to (III):

Step (I): at least a part of the oligomers having a molecular weight of 1000 or less contained in the polyester resin is removed from the polyester resin to produce a low oligomer resin which is a binder resin having a decreased oligomer content;

Step (II): an aggregated particles-forming step in which the fine particles of the low oligomer resin and fine particles of the release agent are aggregated in an aqueous medium to form aggregated particles, or fine particles containing the low oligomer resin and the release agent are aggregated in an aqueous medium to form aggregated particles; and

Step (III): a coalescing step in which the aggregated particles are heated in an aqueous medium to coalesce components contained in the aggregated particles to obtain shape-controlled toner particles.

According to the production method of the toner particles of the toner of the present disclosure, the toner particles of the toner for electrostatic latent image development having excellent fixability at low temperatures can be produced by containing a large amount of the release agent through the steps (I) to (III) described above.

The production method of the toner particles of the toner for electrostatic latent image development of the present disclosure may include, in addition to the steps (I) to (III) described above, the following steps (IV) to (VI), if necessary.

Step (IV): a cleaning step in which the shape-controlled toner particles are cleaned.

Step (V): a drying step in which the shape-controlled toner particles are dried.

Step (VI): an external addition step in which an external additive is attached to a surface of the shape-controlled toner particles.

Hereinafter, Steps (I) to (VI) are explained in order.

### (Step (I))

In Step (I), at least a part of the oligomers having a molecular weight of 1000 or less contained in the polyester resin is removed from the polyester resin to produce a low oligomer resin which is a binder resin having a decreased oligomer content.

The production method of the low oligomer resin is not particularly limited, so long as the method can produce low oligomer resins having a component ratio of oligomers with a molecular weight of 1000 or less in the toner, measured in the pre-determined method, of 1000 mass ppm or less.

The method for removing at least a part of the oligomers having a molecular weight of 1000 or less contained in the polyester resin, which is the binder resin, may include a method in which the polyester resin is treated with an aqueous solution of a basic substance; and a method in which the polyester resin is treated with an organic solvent capable of selectively dissolving the low molecular weight components having a molecular weight of 1000 or less in the polyester resin. Of these methods, the preferable method is treating the polyester resin with the aqueous solution of the basic substance, because of its high removal efficiency of the oligomers in the polyester resin.

When the polyester resin is treated with the aqueous solution of the basic substance or the organic solvent, it is preferable to use pulverized polyester resin particles. The particle diameter of the pulverized polyester resin particles is preferably 10 μm or more and 1 mm or less, more preferably 10 μm or more and 100 μm or less, and particularly preferably 10 μm or more and 50 μm or less. When the particle diameter of the target polyester resin is too small, the pulverization operation is not easy. When the particle diameter of the target polyester resin is too large, the removal efficiency of oligomers is reduced.

A method in which a polyester resin is treated with an aqueous solution containing a basic substance is explained below, as the preferable example of the method of removing at least a part of the oligomers having a molecular weight of 1000 or less contained in the polyester resin. The method of removing the specific oligomers from the polyester resin is not limited to the method described below.

First, a polyester resin is pulverized into particles having a particle diameter of about 20 to 40 μm using a pulverizing apparatus, thereby obtaining a polyester resin powder. The obtained polyester resin powder is mixed with an aqueous solution of a basic substance and water to obtain a mixture. The temperature of the obtained mixture is elevated to a temperature higher than the melting point of the polyester resin. After the temperature of the mixture is cooled to a normal temperature, the mixture is filtered to give the polyester resin. The recovered polyester resin is washed with water and dried to obtain a low oligomer resin having a decreased oligomer content, which is a binder resin.

The basic substance which can be used in the method described above is not particularly limited, so long as it can remove the oligomers from the polyester resin. Specific examples of the basic substance may include alkali metal hydroxides such as sodium hydroxide, potassium hydroxide, and lithium hydroxide, alkali metal carbonate salts such as sodium carbonate and potassium carbonate. The basic substances may be used in a combination of two or more.

### (Step (II): Aggregated Particles-Forming Step)

In Step (II), the fine particles of the low oligomer resin and the fine particles of the release agent are aggregated in an aqueous medium to form aggregated particles, or fine particles containing the low oligomer resin and the release agent are aggregated in an aqueous medium to form aggregated particles.

The method for forming the aggregated particles can be appropriately selected from conventionally known methods. It is preferable that the fine particles of the low oligomer resin, the fine particles of the release agent, and the fine particles containing the low oligomer resin and the release agent are produced as an aqueous dispersion of the fine particles, in which the above-listed components or compositions including the components are microparticulated into fine particles with a desired size. When the fine particles are aggregated, it is also preferable, as required, to use fine particles of a colorant, in addition to the fine particles of the low oligomer resin, the fine particles of the release agent, or the fine particles containing the low oligomer resin and the release agent.

The production method of the fine particles of the low oligomer resin, the production method of the fine particles of the release agent, the production method of the fine particles containing the low oligomer resin and the release agent, the production method of the fine particles of the colorant, and the aggregation method of the fine particles are explained below in order.

### Production Method of Fine Particles of Low Oligomer Resin

A preferable example of the method for producing the fine particles of the low oligomer resin is explained. The method for producing the fine particles of the low oligomer resin is not limited to the method explained below.

First, the temperature of the low oligomer resin is heated to a temperature higher than the melting point thereof to obtain a melt of the low oligomer resin. A temperature at which the low oligomer resin is melted is not particularly limited so long as the low oligomer resin can melt uniformly, and temperatures 10 to 30° C. higher than the melting point of the low oligomer resin are preferable.

In order to neutralize acid groups contained in the low oligomer resin (polyester resin), a basic substance may be added to the low oligomer resin in a melted state. The basic substance is not particularly limited so long as it can neutralize the acid groups contained in the polyester resin. Preferable basic substances may include alkali metal hydroxides such as sodium hydroxide, potassium hydroxide and lithium hydroxide; alkali metal carbonates such as sodium carbonate and potassium carbonate; alkali metal hydrogencarbonates such as sodium hydrogencarbonate and potassium hydrogencarbonate; and nitrogen-containing organic bases such as N,N-dimethyl ethanol amine, N,N-diethyl ethanol amine, triethanol amine, tripropanol amine, tributanol amine, triethyl amine, n-propyl amine, n-butyl amine, isopropyl amine, monomethanol amine, morpholine, methoxypropyl amine, pyridine, and vinyl pyridine. These basic compounds may be used alone or in a combination of two or more.

The amount of the basic compound used is preferably 1 part by mass or more and 20 parts by mass or less, and more preferably 5 parts by mass or more and 15 parts by mass or less, based on 100 parts by mass of the low oligomer resin.

A surfactant may be added to the melt of the low oligomer resin. When the surfactant is added to the melt of the low oligomer resin, the fine particles of the low oligomer resin can be stably dispersed in an aqueous medium.

The surfactant which can be added to the melt of the low oligomer resin may be appropriately selected from the group consisting of anionic surfactants, cationic surfactants, and nonionic surfactants. Examples of the anionic surfactant may include sulfuric acid ester salt type surfactants, sulfonic acid salt type surfactants, phosphoric acid ester salt type surfactants, and soaps. Examples of the cationic surfactant may include amine salt type surfactants and quaternary ammonium salt type surfactants. Examples of the nonionic surfactant may include polyethylene glycol type surfactants, alkyl phenol ethylene oxide adduct type surfactants, and polyhydric alcohol type surfactants which are derivatives of polyhydric alcohols such as glycerin, sorbitol and sorbitan. Of these surfactants, it is preferred to use at least one of the anionic surfactant and the nonionic surfactant. These surfactants may be used alone or in a combination of two or more.

Polyoxyethylene alkylether sulfates are preferable as the anionic surfactant. Among the polyoxyethylene alkylether sulfates, those expressed by Formula (I) below are preferable.

R¹—O—(CH₂CH₂O)ₚ—SO₃M (1)

In Formula (I), R¹ is an alkyl group, M is a monovalent cation, and p is an integer of 1 or more and 50 or less.

R¹ may be a linear alkyl group or a branched alkyl group and is preferably a linear alkyl group. R¹ may have an unsaturated bond. The number of carbon atoms in R¹ is preferably 10 or more and 20 or less, and more preferably 12 or more and 18 or less. p is an integer of 1 or more and 50 or less. p is preferably an integer of 1 or more and 30 or less, and more preferably 2 or more and 20 or less since the particle diameter of fine particles may be easily controlled within a desired range. M is a monovalent cation. M is preferably sodium ion, potassium ion, or ammonium ion, more preferably sodium ion or ammonium ion, and particularly preferably sodium ion since the particle diameter of fine particles may be easily controlled within a desired range.

The polyoxyethylene alkylether sulfate described above is preferably used together with the nonionic surfactant. In this case, a polyoxyethylene alkylether is preferably used as the nonionic surfactant. This is because, when producing fine particles of a low oligomer resin, microparticulation of the fine particles of the low oligomer resin may properly progress and thus the dispersion of fine particles of the low oligomer resin with excellent dispersion stability may be easily obtained.

The amount of the surfactant used is preferably 1% by mass or more and 10% by mass or less based on the mass of the low oligomer resin.

The thus produced melt of the low oligomer resin is added with water, and the mixture is stirred and mixed, whereby the aqueous dispersion containing the fine particles of the low oligomer resin medium can be produced. As a device for stirring the melt of the low oligomer resin and water, a stirrer having a function capable of heat-retaining of the content for maintaining the low oligomer resin in a melted state is preferable. A preferable method for heat-retaining of the content in the stirrer may include a method in which a stirrer provided with a jacket is used, and warm water at a pre-determined temperature, steam or heating medium oil is circulated in the jacket. Specific examples of the preferable stirrer may include a heat kneader (TK Hivis Disper Mix HM-3D-5 (manufactured by Primix Corporation)).

The particle diameter of the fine particles of the low oligomer resin dispersed in the aqueous medium can be controlled by controlling the stirring speed when the melt of the low oligomer resin and water are mixed. A volume average particle diameter (D₅₀) of the fine particles of the low oligomer resin is preferably 1 μm or less, more preferably 0.05 μm or more and 0.5 μm or less. When the particle diameter of the fine particles of the low oligomer resin is within this range, the toner having a sharp particle diameter distribution and uniform shape can be easily obtained, thus resulting in small variations in the toner properties and productivity. The volume average particle diameter (D₅₀) of the fine particles of the low oligomer resin can be measured using a laser diffraction/scattering type particle diameter distribution measuring apparatus (for example, LA-950 (manufactured by Horiba Ltd.))

### Production Method of Fine Particles of Release Agent

A preferable example of the method for producing the fine particles of the release agent is explained below. The method for producing the fine particles of the release agent is not limited to the method explained below.

First, the release agent is previously pulverized into particles with a particle size of about 100 μm or less, thereby obtaining a powder of the release agent. The powder of the release agent is added to an aqueous medium containing a surfactant to produce slurry. Then, the obtained slurry is heated to a temperature higher than a melting point of the release agent. A strong shear force is applied to the heated slurry using a homogenizer or a pressure-discharge type disperser to produce an aqueous dispersion containing fine particles of the release agent.

The device to apply a strong shear force to the aqueous dispersion may be exemplified by NANO3000 (by Beryu Co.), Nanomizer (by Yoshida Kikai Co.), Microfluidizer (by MFI Co.), Gaulin homogenizer (Manton-Gaulin Co.), and Clearmix W-Motion (by M. Technique Co.).

The volume average particle diameter (D₅₀) of the fine particles of the release agent contained in the aqueous dispersion of the fine particles of the release agent is preferably 1 μm or less, more preferably 0.1 μm or more and 0.7 μm or less. When the fine particles of the release agent having a particle diameter within this range are used, the toner in which the release agent is uniformly dispersed in the binder resin can be easily obtained. The volume average particle diameter (D₅₀) of the fine particles of the release agent can be measured in the same manner as in the case of the volume average particle diameter (D₅₀) of the fine particles of the low oligomer resin.

### Production Method of Fine Particles Containing Low Oligomer Resin and Release Agent

A preferable example of the method for producing the fine particles containing the low oligomer resin and the release agent is explained below. The method for producing the fine particles containing the low oligomer resin and the release agent is not limited to the method described below.

The fine particles containing the low oligomer resin and the release agent can be produced in the same manner as in the preferable method for producing the fine particles of the low oligomer resin described above, except that the release agent is contained in the melt of the low oligomer resin.

The method for containing the release agent in the melt of the low oligomer resin is not particularly limited. The preferable method for incorporating the release agent in the melt of the low oligomer resin may include (i) a method in which the low oligomer resin in the solid state and the release agent are mixed, and then the obtained mixture is melted; (ii) a method in which, after the release agent is heated to melt it, the low oligomer resin is added to the melted release agent, and the mixture is heated to melt it; and (iii) a method in which, after the low oligomer resin is heated to melt it, the release agent is added to the melted low oligomer resin, and the mixture is heated to melt it.

### Production Method of Fine Particles of Colorant

A preferable example of the method for producing the fine particles of the colorant is explained below. The method for producing the fine particles of the colorant is not limited to the method described below.

The fine particles containing the colorant can be obtained by dispersion treatment of the colorant and, if necessary, components such as a dispersing agent using a known disperser in an aqueous medium containing a surfactant. Any kind of anionic surfactants, cationic surfactants and nonionic surfactant may be used as the surfactant. The amount of the surfactant used is not particularly limited, and a critical micelle concentration (CMC) or more is preferable.

As the disperser used in the dispersion treatment, pressure-type homogenizers such as an ultrasonic disperser, a mechanical homogenizer, a Manton-Gaulin homogenizer, and a compression homogenizer; and medium-type dispersers such as a sand grinder, a horizontal- or vertical-type bead mill, Ultra Apex Mill (manufactured by Kotobuki Industries Co., Ltd.), Dyno-Mill (manufactured by WAB Inc.), and MSC Mill (Nippon Coke & Engineering Co., Ltd.) may be used.

The volume average particle diameter (D₅₀) of the fine particles of the colorant is preferably 0.05 μm or more and 0.2 μm or less.

### Aggregation Method of Fine Particles

Using the various kinds of the fine particles produced in the methods described above, the aqueous dispersion of the fine particles, which contains the fine particles of the low oligomer resin and the fine particles of the release agent, or the aqueous dispersion of the fine particles containing the low oligomer resin and the release agent is produced, and then the fine particles contained in the aqueous dispersion of the fine particles are aggregated to form aggregated particles. The aqueous dispersion described above may further contain the fine particles of the colorant, if necessary.

The method for aggregating the fine particles may include a method in which an aggregating agent is added to the aqueous dispersion in the aqueous medium containing the fine particles.

Examples of the aggregating agent may be exemplified by inorganic metal salts, inorganic ammonium salts, and divalent or higher metal complexes. The inorganic metal salt may be exemplified by metal salts such as sodium sulfate, sodium chloride, calcium chloride, calcium nitrate, barium chloride, magnesium chloride, zinc chloride, aluminum chloride, and aluminum sulfate; and inorganic metal salt polymers such as poly aluminum chloride and poly aluminum hydroxide. The inorganic ammonium salt may be exemplified by ammonium sulfate, ammonium chloride, and ammonium nitrate. Cationic surfactants of quaternary ammonium salt type and polyethylenimines may also be used as the aggregating agent.

Divalent metal salts and monovalent metal salts are preferably used as the aggregating agent. An aggregation rate of the fine particles in the case of using the monovalent metal salt is slower than the aggregation rate of the fine particles in the case of using the divalent metal salt. The aggregation rate of the fine particles can be controlled, accordingly, by using the divalent metal salt, and then using the monovalent metal salt as the aggregating agents. As stated above, since the divalent metal salt is different from the monovalent metal salt in the aggregation rate of the fine particles, when these are used in combination thereof, the particle size distribution can be easily made sharp along with controlling the particle diameter of the obtained aggregated particles.

The additive amount of the aggregating agent is preferably 0.1 mmol/g or more and 10 mmol/g or less based on solid content of the dispersion of the fine particles. Preferably, the additive amount of the aggregating agent is appropriately adjusted depending on the type and the amount of the surfactant in the dispersion of the fine particles.

The aggregating agent is added at a temperature of no higher than the glass transition point of the binder resin after adjusting the pH of the dispersion of the fine particles. It is preferred that the aggregating agent is added after adjusting the pH of the aqueous dispersion of the fine particles to an alkali side of preferably pH 10 or higher. Fine particles can be uniformly aggregated by the above-mentioned process, thus the particle size distribution of the aggregated particles can be made shape. The aggregating agent may be added at one time or gradually.

After the aggregated particles have aggregated into ones with an intended particle diameter; preferably, a aggregation-terminating agent is added. The aggregation-terminating agent may be exemplified by sodium chloride and sodium hydroxide. In this way, the aggregated particles can be obtained.

### (Step (III): Coalescing Step)

In the coalescing step, the aggregated particles, obtained in Step (II), are heated in an aqueous medium to coalesce the components contained in the aggregated particles, thereby forming toner particles. In the coalescing step, the shape of the aggregated particles gradually comes to be spherical as the aggregated particles are heated. This is because the melt viscosity of the binder resin decreases as the temperature rises and thus the shape of the aggregated particles deforms toward a spherical shape by action of surface tension. By controlling the heating temperature and the heating period during the heating operation, the sphericity of the toner particles obtained can be controlled to an intended value.

The temperature at which the aggregated particles are heated in the coalescing step is not particularly limited so long as the coalescence of the components contained in the aggregated particles can properly proceed. The temperature at which the aggregated particles are heated is preferably a temperature in a temperature range between a temperature 10° C. higher than the glass transition temperature (Tg) of the binder resin or higher and a temperature lower than the melting point (Tm) of the binder resin. When the aggregated particles are heated to a temperature within this range, the coalescence of the components contained in the aggregated particles can properly proceed, and the toner having a preferable sphericity can be easily produced.

### (Step (IV): Washing Step)

The toner particles obtained from Step (III) are washed with water in a washing step (III) as required. The washing method may include by the following methods. The method may include a method in which the toner particles are recovered from the dispersion of toner particles as a wet cake through solid-liquid separation and the obtained wet cake is washed with water; and a method in which the toner particles in the dispersion of the toner particles are precipitated and the supernatant solution is substituted by water followed by re-dispersing the toner particles in water. A method for washing using a filter press apparatus is especially preferable.

### (Step (V): Drying Step)

The toner particles obtained from Step (IV) are dried as required. The method for drying the toner particles is not particularly limited. Preferable drying methods may include a method using a dryer such as a spray dryer, fluidized-bed dryer, vacuum freeze dryer, or decompression dryer. Of these methods, the method using a spray dryer is more preferable since agglomeration of toner particles during drying may be easily suppressed. When using the spray dryer, an external additive can be attached to a surface of toner particles by spraying a dispersion of the external additive such as silica together with the dispersion of toner particles.

### (Step (VI): External Addition Step)

The toner for electrostatic latent image development, produced using the method of the present disclosure, may have adhered thereto an external additive on its surface as required. A preferable method may include a method of mixing it while adjusting a mixing condition such that the external additive is not embedded onto the surface of the toner using a mixer like Henschel mixer or Nauta mixer.

When the method for producing the toner for electrostatic latent image development of the second embodiment of the present disclosure as explained above is used, the toner containing a large amount of the release agent in the binder resin can be produced. When the method for producing the toner for electrostatic latent image development of the second embodiment is used, the toner for electrostatic latent image development which can be properly fixed across a wide temperature range, including a low temperature range, can be produced.

### EXAMPLES

The present disclosure is explained more specifically with reference to Examples below. Additionally, the present disclosure is not limited to the range of Examples. In Examples and Comparative Examples, a polyester resin prior to the treatment of removing the oligomers may also be referred to as a “high oligomer resin.”

### Preparation Example 1

### (Preparation of Polyester Resins A to I)

A polyester resin a, described below, was used as the high oligomer resin. The polyester resin a was treated with a 1 N aqueous sodium hydroxide solution in an amount described in Table 1 to obtain polyester resins A to I, which were low oligomer resins which were made from the polyester resin by removing at least a part of oligomers having a molecular weight of 1000 or less from the polyester resin. Component ratio of the oligomers having a molecular weight of 1000 or less in the polyester resins A to I, based on the mass of the polyester resin, are described in Table 1.

Specifically, the polyester resin a was first pulverized using a pulverizer to obtain a polyester resin powder having an average particle diameter of about 50 μm. Subsequently, 200 g of the obtained polyester resin powder, the amount described in Table 1 of the 1 N aqueous sodium hydroxide solution, and 700 g of deionized water were mixed using a mixer to obtain an aqueous dispersion of the polyester resin powder.

The obtained aqueous dispersion of the polyester resin powder was thrown into a 2 L stainless-steel round-bottom vessel equipped with a condenser and a stirrer. An anionic surfactant was added to the vessel at 1% by mass based on the mass of the resin. After the temperature of the dispersion in the vessel was heated to 95° C., the dispersion was stirred at the same temperature at 200 rpm for 30 minutes. After that, the content in the vessel was quickly cooled to an ordinary temperature, and then the aqueous dispersion of the polyester resin powder was filtered through a filter with #300-mesh to obtain a wet cake of the low oligomer resin. The wet cake of the low oligomer resin was washed with water and dried to obtain each polyester resin A to I, which was a low oligomer resin.

### Polyester Resin a

Monomer Composition: polyoxypropylene (2,2)-2,2-bis(4-hydroxyphenyl)propane/polyoxyethylene (2,0)-2,2-bis(4-hydroxyphenyl) propane/fumaric acid/trimellitic acid=45/5/35/15 (mole ratio)

Number Average Molecular Weight (Mn): 2,260

Mass Average Molecular Weight (Mw): 5,350

Molecular Weight Distribution (Mw/Mn): 2.37

Melting Point (Tm): 91° C.

Glass Transition Point (Tg): 51° C.

Acid Value: 18.6 mg KOH/g

### (Calculation Method of Oligomer Component Ratio)

A content of the oligomers having a molecular weight of 1000 or less contained in the low oligomer resin was measured in accordance with the following procedures.

100 g of the low oligomer resin was stirred in 500 g of methanol at 60° C. for 8 hours to obtain a methanol extract containing oligomers derived from the low oligomer resin. Only the methanol was distilled away from the methanol extract using a rotary evaporator. The residue was dissolved in THF, and a content (concentration) of the oligomers having a molecular weight of 1000 or less contained in the methanol extract was measured using gel permeation chromatography (GPC). From the measurement results of GPC, a mass X (g) of the oligomers having a molecular weight of 1000 or less contained in the whole amount of the methanol extract residue was found. Then, the component ratio Y (mass ppm) of the oligomers having a molecular weight of 1000 or less in the binder resin was calculated according to the following formula:

Y=(X/100(mass of the resin))×1000000.

### (Measurement Method of Amount of Oligomers Having Molecular Weight of 1000 or Less Using GPC)

The measurement method of an amount of the oligomers having a molecular weight of 1000 or less using GPC was performed according to the following method.

Tetrahydrofuran (THF) was used as a medium. A sample to be measured was dissolved in a concentration of 1.5 mg/mL in THF. The obtained THF solution was passed through a filter to obtain a sample solution for measurement used for the GPC measurement. The GPC measurement was performed using the following apparatus under conditions described below. Specifically, after a column was stabilized at a temperature of 40° C., the GPC measurement was performed by flowing the THF solution through the column at the same temperature at a flow rate of 0.35 mL/min. A molecular weight distribution of the sample was obtained by using a calibration curve, produced using several kinds of monodispersed polystyrenes.

A GPC of a monodispersed standard polystyrene having a number average molecular weight of 1000 was measured, a retention volume (mL) was obtained at a peak position, and it was defined as RVS. The GPC of a residue, which is obtained by distilling methanol away from the methanol extract, was measured. The ratio of an area of a part of RVS or less on the low molecule side to the whole area of the peak of the GPC chromatogram was calculated. In this step, only an oligomer part was separately fractionated by a preparative liquid chromatography, and a monomer composition of the oligomer part was detected by using pyrolysis chromatography. At this time, the composition of the oligomer part was totally the same as the composition of the whole copolymer. It was assumed accordingly that there was no difference in the index of refraction between the oligomer part and the whole copolymer, and the amount of the oligomers having a molecular weight of 1000 or less was obtained calculating from the peak area ratio of the oligomer part to the whole copolymer.

### GPC Measurement Condition

Apparatus: HLC-8320 (manufactured by Tosoh Corporation)

Eluent: THF (tetrahydrofuran)

Column: TSK gel SuperMultiporeHZ-M (manufactured by Tosoh Corporation)

The number of columns: Three

Detector: RI

Eluent Flow Rate: 0.35 mL/min

Concentration of Sample Solution: 2.0 g/L

Column Temperature: 40° C.

Amount of Sample Solution: 10 μL

Preparation of Sample Solution: After by shaking the eluent and the sample using a shaker for 1 hour, the sample was dissolved in the eluent, the solution was passed through a filter (pore size of 5 μm).

Calibration Curve: Produced using standard polystyrene.

The results of the component ratio of the oligomers (a molecular weight of 1000 or less), obtained under the measurement conditions described above, are shown in Table 1 below.

TABLE 1

| | | Component ratio of |
|---|---|---|
| | Aqueous sodium | the oligomers in |
| Type of | hydroxide solution | the binder resin |
| resin | [g] | [mass ppm] |
| a | — | 3290 |
| A | 5 | 2990 |
| B | 10 | 2300 |
| C | 15 | 1480 |
| D | 20 | 990 |
| E | 25 | 550 |
| F | 30 | 220 |
| G | 40 | 190 |
| H | 50 | 130 |
| I | 55 | 80 |

### Preparation Example 2

### (Preparation of Resins J to L)

Polyester resins J to L, which were low oligomer resins, were produced in the same manner as in Preparation Example 1, except that a polyester resin b described below was used as the high oligomer resin, and the 1 N aqueous sodium hydroxide solution was used in the amounts described in Table 2. Component ratio of the oligomers having a molecular weight of 1000 or less in the polyester resins J to L are described in Table 2.

Polyester Resin b

Monomer Composition: polyoxypropylene (2,2)-2,2-bis(4-hydroxyphenyl)propane/polyoxyethylene (2,0)-2,2-bis(4-hydroxyphenyl) propane/fumaric acid/trimellitic acid=25/25/46/4 (mole ratio)

Number Average Molecular Weight (Mn): 1,440

Mass Average Molecular Weight (Mw): 3,300

Molecular Weight Distribution (Mw/Mn): 2.29

Melting Point (Tm): 90° C.

Glass Transition Point (Tg): 53° C.

Acid Value: 28.9 mg KOH/g

TABLE 2

| | | Component ratio of |
|---|---|---|
| | Aqueous sodium | the oligomers in |
| Type of | hydroxide solution | the binder resin |
| resin | [g] | [mass ppm] |
| b | — | 6500 |
| J | 30 | 1800 |
| K | 35 | 970 |
| L | 45 | 450 |

### Preparation Example 3

### (Resins M to O)

Polyester resins M to 0, which were low oligomer resins, were produced in the same manner as in Preparation Example 1, except that a polyester resin c described below was used as the high oligomer resin, and a 1 N aqueous sodium hydroxide solution was used in amounts described in Table 3. Component ratio of the oligomers having a molecular weight of 1000 or less in the polyester resins M to 0 are described in Table 3.

Polyester Resin c

Monomer Composition: polyoxypropylene (2,2)-2,2-bis(4-hydroxyphenyl)propane/polyoxyethylene (2,0)-2,2-bis(4-hydroxyphenyl) propane/fumaric acid/trimellitic acid=25/4/45/4 (mole ratio)

Number Average Molecular Weight (Mn): 3,300

Mass Average Molecular Weight (Mw): 8,700

Molecular Weight Distribution (Mw/Mn): 2.64

Melting Point (Tm): 85° C.

Glass Transition Point (Tg): 43° C.

Acid Value: 19.3 mg KOH/G

TABLE 3

| | | Component ratio of |
|---|---|---|
| | Aqueous sodium | the oligomers in |
| Type of | hydroxide solution | the binder resin |
| resin | [g] | [mass ppm] |
| c | — | 2300 |
| M | 10 | 1600 |
| N | 15 | 980 |
| O | 30 | 80 |

### Examples 1 to 10 and Comparative Examples 1 to 8

### [Step (II)]

Using the kind of polyester resin described in Table 5 to 7 as the binder resin, a dispersion of the fine particles of the binder resin was produced. A dispersion of the fine particles of the release agent and a dispersion of the fine particles of a pigment were produced, apart from the dispersion of the fine particles of the binder resin.

### (Production Method of Dispersion of Fine Particles of Binder Resin)

The polyester resin, which was used as the binder resin, was thrown into a heat kneader (TK Hivis Disper Mix HM-3D-5 (manufactured by Primix Corporation)) provided with a jacket for controlling the temperature. The polyester resin was heated to 120° C. while stirring at 20 rpm and rotating at 48 rpm to melt it. After that, 40 g of triethanol amine (a basic compound) and 80 g of an aqueous solution of sodium lauryl sulfate (a surfactant, Emal O (manufactured by Kao Corporation)) in a concentration of 25% by mass were added to the melt, and then the stirring was continued at 40 rpm with rotating at 97 rpm for 30 minutes. Then, 2880 g of deionized water having a temperature of 98° C. at a speed of 50 g/min was added to the melt with an adding speed of 50 g/min to obtain an emulsion of the resin. Subsequently, the emulsion was cooled to 50° C. at a rate of 5° C./min to obtain a dispersion of the fine particles of the binder resin. The obtained dispersion of the fine particles of the binder resin had a solid concentration of 25% by mass. The average particle diameter of the resin fine particles contained in the dispersion of the fine particles of the binder resin was 115 nm. The average particle diameter of the fine particles of the binder resin was measured using a particle diameter measuring apparatus (LA-950 (manufactured by Horiba Ltd.)).

### (Production Method of Dispersion of Fine Particles of Release Agent)

After 200 g of a release agent (an ester wax, WEP-3 (manufactured by NOF Corporation)), 2 g of sodium lauryl sulfate (Emal O (manufactured by Kao Corporation)), and 798 g of deionized water were mixed and the mixture was heated to 90° C., the mixture was emulsified with Cleamix (CLM-2.2 S (manufactured by M Technique Co., Ltd.)) for 10 minutes to obtain a dispersion of the fine particles of the release agent. The obtained dispersion of the fine particles of the release agent had a solid concentration of 10% by mass. The average particle diameter of the fine particles of the release agent contained in the dispersion of the fine particles of the release agent was 250 nm. The average particle diameter of the fine particles of the release agent was measured in the same manner as in the case of the average particle diameter of the fine particles of the binder resin.

### (Production Method of Dispersion of Fine Particles of Pigment)

Mixed were 100 g of a pigment (a cyan pigment, C.I. pigment blue 15:3 (copper phthalocyanine)), 20 g of polyoxyethylene sodium lauryl sulfate (Emal E 27 C (manufactured by Kao Corporation)), and 380 g of deionized water, and the mixture was subjected to a dispersion treatment for 2 hours using Ultra Apex Mill (manufactured by Kotobuki Industries Co., Ltd.) to obtain a dispersion of the fine particles of the pigment. The obtained dispersion of the fine particles of the pigment had a pigment concentration of 20% by mass, and a total solid concentration of 21% by mass. The average particle diameter of the fine particles of the pigment contained in the dispersion of the fine particles of the pigment was 113 nm. The average particle diameter of the fine particles of the pigment was measured in the same manner as in the case of the particle diameter of the fine particles of the binder resin.

Into a 2 L stainless steel round-bottom flask were thrown 340 g of the dispersion of the fine particles of the resin, 100 g of the dispersion of the fine particles of the release agent, 25 g of the dispersion of the fine particles of the pigment, which were produced using the method described above, and 500 g of deionized water, and mixed at 25° C. Next, the mixture in the flask was stirred at 200 rpm using impellers. After the pH of the mixture in the flask was adjusted to 10 using an aqueous sodium hydroxide solution, the mixture was stirred for 10 minutes. After that, 10 g of an aqueous solution of magnesium chloride hexahydrate (an aggregating agent) in a concentration of 50% by mass was added dropwise to the flask over 5 minutes. Subsequently, the temperature of the mixture in the flask was elevated at a rate of 0.2° C./min, to allow the aggregation of the fine particles to start. After the temperature increase was stopped at 50° C., the temperature of the mixture in the flask was maintained at 50° C. for 30 minutes by stirring it to advance aggregation of the fine particles. After that, 50 g of an aqueous solution of sodium chloride in a concentration of 20% by mass was added to the flask to stop the advance of the aggregation of the fine particles, thereby obtaining a dispersion of aggregated particles in the aqueous medium.

### [Step (III)]

To the obtained aqueous dispersion of the aggregated particles was added 100 g of a 25% by mass aqueous solution containing 5% by mass of sodium lauryl sulfate (Emal O (manufactured by Kao Corporation)). Next, the temperature of the aqueous dispersion of the aggregated particles was elevated to 65° C. at a temperature-increase rate of 0.2° C./min. The toner components contained in the aggregated particles were coalesced and the shape of the each of the aggregated particles was controlled into a spherical shape by stirring the dispersion at 65° C. for 1 hour. After that, the temperature of the aqueous dispersion of the aggregated particles was dropped to 25° C. at a rate of 10° C./min to obtain aqueous dispersion of a toner containing the shape-controlled fine particle aggregated particles as the toner particles.

### [Step (IV): Washing Step]

Using a Buchner funnel, the toner dispersion was filtered to obtain a wet cake of the toner. The wet cake of the toner was dispersed in deionized water again to wash the toner particles. The same washing was repeated 6 times using deionized water.

### [Step (V): Drying Step]

A slurry was produced by dispersing the wet cake of the toner in a 50% by mass aqueous ethanol solution. The obtained slurry was supplied to a continuous surface-modifying device (Coatmizer (manufactured by Freund Sangyo Co., Ltd.)) to dry the toner particles in the slurry, thereby obtaining a toner. The drying conditions upon using Coatmizer were the hot-air temperature of 45° C. and a blower air flow of 2 m³/min.

The toner particles in the toner of each Example 1 to 10 and Comparative Example 1 to 8, obtained in this way, was measured for the volume average particle diameter (MV), an MV/MN value, and the spherical degree using a particle size distribution analyzer (Microtrac UPA 150, by Nikkiso Co.). The measurement results of the volume average particle diameter (MV), the MV/MN value, and the spherical degree of the toner from Examples 1 to 10 and Comparative Examples 1 to 8 are described in Table 4.

TABLE 4

| | | Volume average | | |
|---|---|---|---|---|
| | Type of | particle diameter | | |
| | resin | [MV(μm)] | MV/MN | Spherical degree |
| Ex. 1 | D | 5.5 | 1.2 | 0.978 |
| Ex. 2 | E | 5.5 | 1.2 | 0.979 |
| Ex. 3 | F | 5.6 | 1.3 | 0.980 |
| Ex. 4 | G | 5.5 | 1.2 | 0.978 |
| Ex. 5 | H | 5.5 | 1.2 | 0.982 |
| Ex. 6 | I | 5.7 | 1.3 | 0.982 |
| Ex. 7 | K | 5.5 | 1.2 | 0.979 |
| Ex. 8 | L | 5.5 | 1.2 | 0.982 |
| Ex. 9 | N | 5.5 | 1.2 | 0.986 |
| Ex. 10 | O | 5.7 | 1.3 | 0.987 |
| Comp. ex. 1 | a | 5.5 | 1.2 | 0.978 |
| Comp. ex. 2 | A | 5.5 | 1.2 | 0.986 |
| Comp. ex. 3 | B | 5.5 | 1.2 | 0.978 |
| Comp. ex. 4 | C | 5.5 | 1.2 | 0.978 |
| Comp. ex. 5 | b | 5.6 | 1.3 | 0.982 |
| Comp. ex. 6 | J | 5.5 | 1.2 | 0.982 |
| Comp. ex. 7 | c | 5.5 | 1.2 | 0.979 |
| Comp. ex. 8 | M | 5.7 | 1.3 | 0.982 |

### [Step (VI): External Addition Step]

An external addition step was performed using the toner particles contained in the toner obtained after the drying step described above as the toner base particles. Mixed were 100 parts by mass of the toner base particles, and 1.5 parts by mass of an external additive (RA 200 HS (manufactured by Nippon Aerosil Co.)) for 5 minutes using a 5 L Henschel mixer (manufactured by Mitsui Miike Machinery Co., Ltd.), thereby attaching the external additive to the toner base particles. After that, the mixture was screened through a 300-mesh screen (opening 48 μm) to obtain a toner (toner particles) for measurement and evaluation of each Example 1 to 10 and Comparative Example 1 to 8.

### Measurement and Evaluation

The toner particles in the toner of each Example 1 to 10 and Comparative Example 1 to 8 was measured for the amount of the oligomers having a molecular weight of 1000 or less contained in the toner particles and the content of the release agent in accordance with the following methods, and the fixability was evaluated. The measurement results of the amount of the oligomers having a molecular weight of 1000 or less, and the content of the release agent of the toner from each Example 1 to 10 and Comparative Example 1 to 8, and the evaluation results of the fixability are described in Tables 5 to 7.

### Amount of Oligomer in Toner

The amount of the oligomers having a molecular weight of 1000 or less derived from the binder resin contained in the toner was measured in the same manner as the measurement method of the oligomer content of the polyester resin described above, except that the toner sample was used instead of the polyester resin sample as the sample in the same mass as that of the polyester resin sample.

### Measurement of Content of Release Agent

Using a differential scanning calorimeter (DSC-6200 (manufactured by Seiko Instruments Inc.) in which melting points of indium and zinc were used for temperature correction of a detection unit; and the heat of fusion of indium was used for correction of a quantity of heat) as a measuring apparatus, an endothermic curve of the toner was measured in accordance with ASTM D 3418-8. In an aluminum pan was put 10 mg of a measurement sample, and an empty aluminum pan was used as a reference. The measurement was performed within a measurement temperature range of 40 to 100° C. at a temperature-increase rate of 10° C./min to obtain an endothermic curve of the toner, and a content of the release agent (% by mass) was obtained from the endothermic curve.

### [Production of Two-Component Developer]

### (Production of Carrier)

A two-component developer to be used in the evaluation of fixability was produced according to the following method.

Starting materials were mixed in amounts of 39.7 mol % in terms of MnO, 9.9 mol % in terms of MgO, and 49.6 mol % in terms of Fe₂O₃, and 0.8 mol % in terms of SrO. Water was added to the mixture of the starting materials, and the mixture was pulverized over 10 hours in a wet ball mill. After the pulverized mixture was dried, the mixture was maintained at 950° C. for 4 hours. Next, the mixture was pulverized over 24 hours in a wet ball mill to produce slurry. After the slurry was dried and granulated, the granules were maintained at 1270° C. for 6 hours in an atmosphere of 2% oxygen concentration, and then they were cracked and subjected to a particle size control to obtain manganese ferrite particles (a carrier core material). The obtained manganese ferrite particles had an average particle diameter of 35 μm and a saturation magnetization of 70 Am²/kg when the applied magnetic field was 3000 (10³/4π·A/m).

Next, a polyamide imide resin (a copolymer of trimellitic anhydride and 4,4′-diaminodiphenyl methane) was diluted with methyl ethyl ketone to produce a resin solution. Tetrafluoroethylene-hexafluoropropylene copolymer (FEP) and silicon oxide (2% by mass of the total amount of the resin) were dispersed in the obtained resin solution to obtain a carrier coating liquid in an amount of 150 g as a solid content. The mass ratio of the polyamide imide resin to the FEP (polyamide imide resin/FEP) was 2/8, and a solid content percentage of the solid solution was 10% by mass.

10 kg of the manganese ferrite particles was coated with the resulting carrier coating liquid using a fluidized-bed coating device (Spiracoater SP-25, by Okada Seiko Co.). Then, the manganese ferrite particles coated with the resin were calcined at 220° C. for 1 hour, thereby obtaining a resin-coated ferrite carrier having a coated resin amount of 1.5% by mass.

### (Mixing of Toner and Carrier)

The toner, obtained in each Example or each Comparative Example, and the carrier were mixed in a mass of the toner of 12.0% by mass to the mass of the two-component developer at an ordinary temperature and normal humidity at the number of revolutions of 78 rpm for 30 minutes using a rocking mixer (RM-10 (manufactured by Aichi Electric Co., Ltd.)) to obtain a two-component developer.

### Evaluation of Fixability

Using the obtained two-component developer and the toner, a non-fixed solid image was formed on a medium to be recorded by using a multi-functional peripheral (TASKalfa 4550 ci (Kyocera Document Solutions Inc.)), with a linear velocity of 400 mm/sec, a loaded toner amount of 4.0 mg/cm². The non-fixed solid image was fixed by elevating a fixing temperature of a fixing device of the multi-function printer from 100° C. in 5° C. increments within a fixing temperature of 100 to 200° C. The fixation lower limit temperature and the fixation upper limit temperature were measured using the obtained fixed image in accordance with a measurement method described below, and the fixation temperature width, the difference between the fixation lower limit temperature and the fixation upper limit temperature, (the fixation upper limit temperature−the fixation lower limit temperature) was calculated. The fixability was evaluated based on criteria described below.

Good: A fixation temperature width of 80° C. or higher

Bad: A fixation temperature width of lower than 80° C.

### (Measurement of Fixation Lower Limit Temperature and Fixation Upper Limit Temperature)

An image density of the fixed solid image was measured before and after a fastness test, and a concentration ratio was calculated from the image densities obtained before and after the fastness test according to the following formula. The temperature at which a solid image having a concentration ratio of 80% or more could be fixed was defined as a fixable temperature. The lower limit of the fixable temperature was defined as the fixation lower limit temperature. Also, the upper limit of the fixable temperature was defined as the fixation upper limit temperature. The fastness test was performed using a JSPS-type friction fastness tester (JIS L 0849 II-type (manufactured by Yasuda Seiki Seisakusho, Ltd.)) in conditions of a load of 200 g and 20 strokes of rubbing operations. The image density was measured using a reflection densitometer (RD-918 (manufactured by Gretag Macbeth, Inc.)).

Concentration Ratio (%)=(image density after friction/image density before friction)×100

TABLE 5

| | | | | Evaluation of Fixability | | | |
|---|---|---|---|---|---|---|---|
| | | Component ratio | | Fixation | Fixation | Fixation | |
| | | of the oligomers in | Content of the | upper limit | lower limit | temperature | |
| | Type of | the binder resin | release agent | temperature | temperature | width | |
| | resin | [mass ppm] | [% by mass] | [° C.] | [° C.] | [° C.] | Results |
| Comp. | a | 2797 | 4.8% | 155 | 115 | 40 | Bad |
| ex. 1 | | | | | | | |
| Comp. | A | 2542 | 4.9% | 155 | 110 | 45 | Bad |
| ex. 2 | | | | | | | |
| Comp. | B | 1955 | 5.5% | 165 | 110 | 55 | Bad |
| ex. 3 | | | | | | | |
| Comp. | C | 1258 | 7.6% | 170 | 110 | 60 | Bad |
| ex. 4 | | | | | | | |
| Ex. 1 | D | 842 | 9.7% | 185 | 105 | 80 | Good |
| Ex. 2 | E | 468 | 10.0% | 185 | 105 | 80 | Good |
| Ex. 3 | F | 187 | 10.0% | 185 | 105 | 80 | Good |
| Ex. 4 | G | 162 | 10.0% | 185 | 105 | 80 | Good |
| Ex. 5 | H | 111 | 10.0% | 185 | 105 | 80 | Good |
| Ex. 6 | I | 68 | 10.0% | 185 | 105 | 80 | Good |

TABLE 6

| | | | | Evaluation of Fixability | | | |
|---|---|---|---|---|---|---|---|
| | | Component ratio | | Fixation | Fixation | Fixation | |
| | | Of the oligomers in | Content of the | upper limit | lower limit | temperature | |
| | Type of | the binder resin | release agent | temperature | temperature | width | |
| | resin | [mass ppm] | [% by mass] | [° C.] | [° C.] | [° C.] | Results |
| Comp. | b | 5525 | 3.5% | 150 | 120 | 30 | Bad |
| ex. 5 | | | | | | | |
| Comp. | J | 1530 | 7.1% | 165 | 115 | 50 | Bad |
| ex. 6 | | | | | | | |
| Ex. 7 | K | 825 | 9.7% | 185 | 105 | 80 | Good |
| Ex. 8 | L | 383 | 10.0% | 185 | 105 | 80 | Good |

TABLE 7

| | | | | Evaluation of Fixability | | | |
|---|---|---|---|---|---|---|---|
| | | Component ratio of | | Fixation | Fixation | Fixation | |
| | | the oligomers in | Content of the | upper limit | lower limit | temperature | |
| | Type of | the binder resin | release agent | temperature | temperature | width | |
| | resin | [mass ppm] | [% by mass] | [° C.] | [° C.] | [° C.] | Results |
| Comp. | c | 1955 | 5.5% | 150 | 110 | 40 | Bad |
| ex. 7 | | | | | | | |
| Comp. | M | 1360 | 6.8% | 155 | 105 | 50 | Bad |
| ex. 8 | | | | | | | |
| Ex. 9 | N | 833 | 9.7% | 180 | 100 | 80 | Good |
| Ex. 10 | O | 68 | 10.0% | 180 | 100 | 80 | Good |

From Examples 1 to 10, it was found that when the toner particles in the toner for electrostatic latent image development is used which contains the polyester resin as the binder resin, and was obtained by aggregating and coalescing the fine particles of the toner material in the pre-determined method, with a component ratio of oligomers having a molecular weight of 1000 or less in the toner particles, measured by a pre-determined method, of 1000 mass ppm or less, the toner particles contained in the toner for electrostatic latent image development can contain a large amount of the release agent in the binder resin, and thus they has good fixability within a wide temperature range including a low temperature range.

From Comparative Examples 1 to 8, it was found that the toner particles in the toner for electrostatic latent image development is used which contains the polyester resin as the binder resin, and was obtained by aggregating and coalescing the fine particles of the toner material in the pre-determined method, but with a component ratio of oligomers having a molecular weight of 1000 or less in the toner particles, measured by a pre-determined method, of more than 1000 mass ppm, the toner particles in the toner for electrostatic latent image development can contain only a small amount of the release agent, and thus the fixable temperature width where the image can be properly fixed on the medium to be recorded is narrow.

1. Toner particles in a toner for electrostatic latent image development, which are formed by aggregating fine particles containing a binder resin and fine particles containing a release agent in an aqueous medium to form aggregated particles, or by aggregating fine particles containing a binder resin and a release agent in an aqueous medium to form aggregated particles, and heating the resulting aggregated particles in an aqueous medium to coalesce components contained in the aggregated particles,
wherein the binder resin is a polyester resin,
and wherein the toner has a component ratio Y (mass ppm) of oligomers having a molecular weight of 1000 or less in the toner, which is calculated in accordance with a method comprising the following steps (1) to (3), of 1000 mass ppm or less.
(1) a step of obtaining a methanol extract, containing oligomer derived from the binder resin, by stirring 100 g of a sample of the toner for electrostatic latent image development in 500 g of methanol at 60° C. for 8 hours,
(2) a step of measuring a content of oligomers having a molecular weight of 1000 or less of oligomers contained in the methanol extract, and obtaining a mass X (g) of the oligomers having a molecular weight of 1000 or less contained in the whole amount of the methanol extract, and
(3) a step of calculating the component ratio in accordance with the following formula:
Y=(X/100(the mass of the toner sample))×1000000.

2. The toner for electrostatic latent image development according to claim 1, wherein the polyester resin has a number average molecular weight of 1,000 or more and 10,000 or less.

3. A method for producing the toner for electrostatic latent image development according to claim 1, comprising the following steps (I) to (III):
(I) a low oligomer resin production step in which at least a part of the oligomers having a molecular weight of 1000 or less contained in the polyester resin is removed from the polyester resin to produce a low oligomer resin which is a binder resin having a decreased oligomer content;
(II) an aggregated particles-forming step in which the fine particles of the low oligomer resin and fine particles of the release agent are aggregated in an aqueous medium to form aggregated particles, or fine particles containing the low oligomer resin and the release agent are aggregated in an aqueous medium to form aggregated particles; and
(III) a coalescing step in which the aggregated particles are heated in an aqueous medium to coalesce components contained in the aggregated particles.
